(19) United States
(12) Patent Application Publication
(10) Pub. No.: US 2021/0398123 A1
(43) Pub. Date: Dec. 23, 2021

(54) Method and System of Access Management Using a Payment Transaction

(71) Applicant: Visa International Service Association, San Francisco, CA (US)

(72) Inventors: Purama Snehasri, Bengaluru (IN); Rajni Varghese, Bangalore (IN)

(21) Appl. No.: 16/907,652

(22) Filed: Jun. 22, 2020

(51) Int. Cl. G06Q 20/40; G06Q 20/10; G06Q 40/02; G05B 15/02; G07C 9/00; G06F 21/35; G06F 16/23

(52) U.S. Cl. CPC G06Q 20/4014; G06Q 20/108; G06Q 40/02; G06Q 20/127; G07C 9/00309; G06F 21/35; G06F 16/2379; G05B 15/02

(57) ABSTRACT

The present disclosure relates to a method and system of access management using a payment transaction. The computer-implemented method includes receiving a payment transaction request and one or more details associated with a lock. Further, the method includes providing one of a success message or a failure message to an access management system to operate the lock based on a result of authorization of the payment transaction request and a result of a validation of the one or more details.

### BACKGROUND

### 1. Technical Field

The present disclosure relates to an access management system. Particularly, but not exclusively, the present disclosure relates to a method and system of access management using a payment transaction.

### 2. Technical Considerations

In this day and age, the vast majority of private residences, businesses, and government premises employ locks on all exterior doors, as well as many interior doors, to control physical access to premises and to protect valuable contents and occupants from outsiders. The technology of access management systems provides a very wide range of choices in security levels, locking mechanisms, and key type for restricting access to outsiders. The type of key used includes mechanical keys, magnetically-coded swipe cards, “smart” cards with embedded microelectronic devices (e.g., a payment card), plastic or metal cards coded with mechanical holes, short-range radio frequency (RF) or infrared (IR) transmitters with coded signals via a user device (for example, a smartphone, a user wearable device, and/or the like), biometric recognition, and/or various keypad arrangements requiring the user to input a predetermined unlocking code.

In the existing access management systems, individual users are forced to carry and manage a large number of mechanical keys or cards. Also, it is often difficult to remember a number of passwords. Lost keys may result, in the case of mechanical keys and cards, with a resulting need to replace or re-key all locks with which the keys were associated. Further, if a number of individual users have keys to a single door and one is lost, all key holders must be contacted and provided with new keys.

Further, in the existing access management systems, the passwords or keypad numbers can be inadvertently or deliberately revealed to the outsiders, thereby reducing the security level associated with a lock. Furthermore, the loss of a user device associated with the lock results in a need to re-program the lock to accept a new code. The access management systems employing biometric recognition techniques have increased costs.

Hence, there is a need for access management systems with higher security, and a reduced cost without the need for mechanical keys or cards.

The information disclosed in this background section is only for enhancement of understanding of the general background of the disclosure and should not be taken as an acknowledgment or any form of suggestion that this information forms the existing art already known to a person skilled in the art.

### SUMMARY

Additional features and advantages are realized through the techniques of the present disclosure. Other embodiments and aspects of the disclosure are described in detail herein and are considered a part of the claimed disclosure.

In some non-limiting embodiments or aspects, provided is a computer-implemented method comprising: receiving, with at least one processor, a payment transaction request and one or more details associated with a lock; and providing, with at least one processor, one of a success message or a failure message to an access management system to operate the lock based on a result of authorization of the payment transaction request and a result of a validation of the one or more details.

In some non-limiting embodiments or aspects, the one or more details comprise at least one of the following: an identification value, account information, a transaction amount associated with the lock, or any combination thereof.

In some non-limiting embodiments or aspects, the computer-implemented method further comprises providing, with at least one processor, the payment transaction request to an issuer server for authorization; and receiving, with at least one processor, the result of the authorization indicative of a success or a failure from the issuer server.

In some non-limiting embodiments or aspects, the validation of the one or more details comprises: verifying the one or more details comprising an identification value associated with the lock, account information associated with the payment transaction request, and a transaction amount associated with the payment transaction request with registered information stored in a database; and generating the result of the validation indicative of success or failure based on the verification of the one or more details.

In some non-limiting embodiments or aspects, providing the success message comprises sending the success message comprising at least one of sender information, a timestamp, and an identification value to the access management system for unlocking the lock, when the result of authorization and the result of the validation is indicative of success, wherein the lock is unlocked by the access management system after verifying the sender information, the timestamp, and the identification value associated with the success message.

In some non-limiting embodiments or aspects, providing the failure message comprises sending the failure message to the access management system associated with the lock to retain the lock in a locked state, when the result of authorization or the result of the validation is indicative of failure.

In some non-limiting embodiments or aspects, the computer-implemented method further comprises initiating, with at least one processor, an authorization reversal request after sending the success message to the access management system.

In some non-limiting embodiments or aspects, the computer-implemented method further comprises receiving, with at least one processor, a notification from the access management system about restoring the lock to a locked state after one of a predefined time period or a user manually locking the lock.

In some non-limiting embodiments or aspects, the computer-implemented method further comprises receiving, with at least one processor, a registration request for operating the lock, wherein the registration request comprises a predefined identification value, a predefined transaction amount, and predefined account information of one or more users associated with the lock; and storing, in a database, the predefined identification value, the predefined transaction amount, and the predefined account information of one or more users as registered information.

In some non-limiting embodiments or aspects, provided is a payment server for operating a lock comprising: at least one processor; and a memory communicatively coupled to the at least one processor, wherein the memory stores processor instructions, which, when executed, cause the at least one processor to: receive a payment transaction request and one or more details associated with the lock; and provide one of a success message or a failure message to an access management system to operate the lock based on a result of authorization of the payment transaction request and a result of validation of the one or more details.

In some non-limiting embodiments or aspects, the at least one processor is configured to receive the one or more details comprising at least one of the following: an identification value, account information, a transaction amount associated with the lock, or any combination thereof.

In some non-limiting embodiments or aspects, the at least one processor is configured to: provide the payment transaction request to an issuer server for authorization; and receive the result of the authorization indicative of a success or a failure from the issuer server.

In some non-limiting embodiments or aspects, the at least one processor is configured to validate the one or more details by: verifying the one or more details comprising an identification value associated with the lock, account information associated with the payment transaction request, and a transaction amount associated with the payment transaction request with registered information stored in a database; and generating the result of the validation indicative of success or failure based on the verification of the one or more details.

In some non-limiting embodiments or aspects, the at least one processor is configured to provide the success message by sending the success message to the access management system for unlocking the lock, when the result of authorization and the result of validation is indicative of success, wherein the lock is unlocked by the access management system after verifying sender information, a timestamp, and an identification value associated with the success message.

In some non-limiting embodiments or aspects, the at least one processor is configured to provide the failure message by sending the failure message to the access management system associated with the lock to retain the lock in a locked state, when the result of the authorization or the result of the validation is indicative of failure.

In some non-limiting embodiments or aspects, the at least one processor is further configured to initiate an authorization reversal request after sending the success message to the access management system.

In some non-limiting embodiments or aspects, the at least one processor is further configured to receive a notification from the access management system about restoring the lock to a locked state after a predefined time period.

In some non-limiting embodiments or aspects, the at least one processor is further configured to: receive a registration request for operating the lock, wherein the registration request comprises a predefined identification value, a predefined transaction amount, and predefined account information of one or more users associated with the lock; and store, in a database, the predefined identification value, the predefined transaction amount, and the predefined account information of one or more users as registered information.

In some non-limiting embodiments or aspects, provided is a computer-implemented method comprising: receiving, with at least one processor, a payment transaction request and one or more details associated with a lock, wherein the payment transaction request is provided to an issuer server for authorization; and in response to receiving a result of the authorization, performing, with at least one processor, at least one of the following: sending a failure message to an access management system associated with the lock to retain the lock in a locked state, when the result of the authorization is indicative of failure; validating the one or more details, when the result of the authorization is indicative of success; or any combination thereof; and in response to a result of validation, performing, with the at least one processor, at least one of the following: sending a success message to the access management system for unlocking the lock, when the result of validation is indicative of success; sending the failure message to the access management system to retain the lock in the locked state, when the result of validation is indicative of failure; or any combination thereof.

In some non-limiting embodiments or aspects, validating the one or more details comprises: verifying, with at least one processor, the one or more details comprising an identification value associated with the lock, account information associated with the payment transaction request, and a transaction amount associated with the payment transaction request with registered information stored in a database; and generating, with at least one processor, the result of the validation indicative of success or failure based on the verification of the one or more details.

Disclosed herein is a computer-implemented method for operating a lock. The computer-implemented method includes receiving a payment transaction request and one or more details associated with a lock. Further, the computer-implemented method includes providing one of a success message or a failure message to an access management system to operate the lock based on a result of authorization of the payment transaction request and a result of a validation of the one or more details.

Further, in some non-limiting embodiments or aspects, the present disclosure may include a payment server for operating a lock, the payment server comprises at least one processor, and a memory communicatively coupled to the at least one processor, wherein the memory stores the at least one processor instructions, which, on execution, causes the at least one processor to receive a payment transaction request and one or more details associated with the lock. Further, the at least one processor is configured to provide one of a success message or a failure message to an access management system to operate the lock based on a result of authorization of the payment transaction request and a result of a validation of the one or more details.

Furthermore, in some non-limiting embodiments or aspects, the present disclosure may include a computer-implemented method for operating a lock comprising receiving a payment transaction request and one or more details associated with a lock, wherein the payment transaction request is provided to an issuer server for authorization. Further, in response to receiving a result of the authorization, the computer-implemented method includes performing at least one of sending a failure message to an access management system associated with the lock to retain the lock in a locked state, when the result of the authorization is indicative of a failure or validating the one or more details when the result of the authorization is indicative of a success. Furthermore, in response to a result of validation, the computer-implemented method includes performing at least one of sending a success message to the access management system for unlocking the lock, when the result of validation is indicative of the success, or sending the failure message to the access management system to retain the lock in the locked state when the result of validation is indicative of the failure.

The foregoing summary is illustrative only and is not intended to be in any way limiting. In addition to the illustrative aspects, embodiments, and features described above, further aspects, embodiments, and features may become apparent by reference to the drawings and the following detailed description.

Further non-limiting embodiments or aspects are set forth in the following numbered clauses:

Clause 1: A computer-implemented method comprising: receiving, with at least one processor, a payment transaction request and one or more details associated with a lock; and providing, with at least one processor, one of a success message or a failure message to an access management system to operate the lock based on a result of authorization of the payment transaction request and a result of a validation of the one or more details.

Clause 2: The computer-implemented method of clause 1, wherein the one or more details comprise at least one of the following: an identification value, account information, a transaction amount associated with the lock, or any combination thereof.

Clause 3: The computer-implemented method of clause 1 or 2, further comprising: providing, with at least one processor, the payment transaction request to an issuer server for authorization; and receiving, with at least one processor, the result of the authorization indicative of a success or a failure from the issuer server.

Clause 4: The computer-implemented method of any of clauses 1-3, wherein the validation of the one or more details comprises: verifying the one or more details comprising an identification value associated with the lock, account information associated with the payment transaction request, and a transaction amount associated with the payment transaction request with registered information stored in a database; and generating the result of the validation indicative of success or failure based on the verification of the one or more details.

Clause 5: The computer-implemented method of any of clauses 1-4, wherein providing the success message comprises sending the success message comprising at least one of sender information, a timestamp, and an identification value to the access management system for unlocking the lock, when the result of authorization and the result of the validation is indicative of success, wherein the lock is unlocked by the access management system after verifying the sender information, the timestamp, and the identification value associated with the success message.

Clause 6: The computer-implemented method of any of clauses 1-5, wherein providing the failure message comprises sending the failure message to the access management system associated with the lock to retain the lock in a locked state, when the result of authorization or the result of the validation is indicative of failure.

Clause 7: The computer-implemented method of any of clauses 1-6, further comprising initiating, with at least one processor, an authorization reversal request after sending the success message to the access management system.

Clause 8: The computer-implemented method of any of clauses 1-7, further comprising receiving, with at least one processor, a notification from the access management system about restoring the lock to a locked state after one of a predefined time period or a user manually locking the lock.

Clause 9: The computer-implemented method of any of clauses 1-8, further comprising receiving, with at least one processor, a registration request for operating the lock, wherein the registration request comprises a predefined identification value, a predefined transaction amount, and predefined account information of one or more users associated with the lock; and storing, in a database, the predefined identification value, the predefined transaction amount, and the predefined account information of one or more users as registered information.

Clause 10: A payment server for operating a lock comprising: at least one processor; and a memory communicatively coupled to the at least one processor, wherein the memory stores processor instructions, which, when executed, cause the at least one processor to: receive a payment transaction request and one or more details associated with the lock; and provide one of a success message or a failure message to an access management system to operate the lock based on a result of authorization of the payment transaction request and a result of validation of the one or more details.

Clause 11: The payment server of clause 10, wherein the at least one processor is configured to receive the one or more details comprising at least one of the following: an identification value, account information, a transaction amount associated with the lock, or any combination thereof.

Clause 12: The payment server of clause 10 or 11, wherein the at least one processor is configured to: provide the payment transaction request to an issuer server for authorization; and receive the result of the authorization indicative of a success or a failure from the issuer server.

Clause 13: The payment server of any of clauses 10-12, wherein the at least one processor is configured to validate the one or more details by: verifying the one or more details comprising an identification value associated with the lock, account information associated with the payment transaction request, and a transaction amount associated with the payment transaction request with registered information stored in a database; and generating the result of validation indicative of success or failure based on the verification of the one or more details.

Clause 14: The payment server of any of clauses 10-13, wherein the at least one processor is configured to provide the success message by sending the success message to the access management system for unlocking the lock, when the result of the authorization and the result of the validation is indicative of success, wherein the lock is unlocked by the access management system after verifying sender information, a timestamp, and an identification value associated with the success message.

Clause 15: The payment server of any of clauses 10-14, wherein the at least one processor is configured to provide the failure message by sending the failure message to the access management system associated with the lock to retain the lock in a locked state, when the result of the authorization or the result of the validation is indicative of failure.

Clause 16: The payment server of any of clauses 10-15, wherein the at least one processor is further configured to initiate an authorization reversal request after sending the success message to the access management system.

Clause 17: The payment server of any of clauses 10-16, wherein the at least one processor is further configured to receive a notification from the access management system about restoring the lock to a locked state after a predefined time period.

Clause 18: The payment server of any of clauses 10-17, wherein the at least one processor is further configured to: receive a registration request for operating the lock, wherein the registration request comprises a predefined identification value, a predefined transaction amount, and predefined account information of one or more users associated with the lock; and store, in a database, the predefined identification value, the predefined transaction amount, and the predefined account information of one or more users as registered information.

Clause 19: A computer-implemented method comprising: receiving, with at least one processor, a payment transaction request and one or more details associated with a lock, wherein the payment transaction request is provided to an issuer server for authorization; in response to receiving a result of the authorization, performing, with at least one processor, at least one of the following: sending a failure message to an access management system associated with the lock to retain the lock in a locked state, when the result of the authorization is indicative of failure; validating the one or more details, when the result of the authorization is indicative of success; or any combination thereof; and in response to a result of the validation, performing, with the at least one processor, at least one of the following: sending a success message to the access management system for unlocking the lock, when the result of the validation is indicative of success; sending the failure message to the access management system to retain the lock in the locked state, when the result of validation is indicative of failure; or any combination thereof.

Clause 20: The computer-implemented method of clause 19, wherein the validating the one or more details comprises: verifying, with at least one processor, the one or more details comprising an identification value associated with the lock, account information associated with the payment transaction request, and a transaction amount associated with the payment transaction request with registered information stored in a database; and generating, with at least one processor, the result of the validation indicative of success or failure based on the verification of the one or more details.

### BRIEF DESCRIPTION OF THE DRAWINGS

The novel features and characteristics of the disclosure are set forth in the appended claims. The disclosure itself, however, as well as a preferred mode of use, further objectives and advantages thereof, may best be understood by reference to the following detailed description of non-limiting embodiments or aspects when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1A is an exemplary environment for operating a lock by performing a payment transaction, in accordance with some non-limiting embodiments or aspects of the present disclosure;

FIG. 1B is an exemplary block diagram of an access management system, in accordance with some non-limiting embodiments or aspects of the present disclosure;

FIG. 2 shows a simplified block diagram of a payment server for operating a lock based on a payment transaction, in accordance with embodiments of the present disclosure;

FIG. 3A and FIG. 3B are flow charts illustrating method steps for operating the lock by performing a payment transaction, in accordance with some non-limiting embodiments or aspects of the present disclosure;

FIG. 4A is exemplary registered information stored in a database, in accordance with some non-limiting embodiments or aspects of the present disclosure;

FIG. 4B is an exemplary payment transaction request received by the payment server, in accordance with some non-limiting embodiments or aspects of the present disclosure;

FIG. 4C is an exemplary operation of the lock from the locked state to the unlocked state, in accordance with some non-limiting embodiments or aspects of the present disclosure;

FIG. 4D is an exemplary void request for authorization reversal of a payment transaction, in accordance with some non-limiting embodiments or aspects of the present disclosure; and

FIG. 5 is an exemplary computer system for operating a lock based on the payment transaction, in accordance with some non-limiting embodiments or aspects of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and/or the like represent various processes which may be substantially represented in computer-readable medium and executed by a computer or processor, whether or not such computer or processor is explicitly shown. While each of the figures illustrates a particular embodiment for purposes of illustrating a clear example, other embodiments may omit, add to, reorder, and/or modify any of the elements shown in the figures.

### DETAILED DESCRIPTION

In the present document, the term “exemplary” is used herein to mean “serving as an example, instance, or illustration.” Any embodiment or implementation of the present subject matter described herein as “exemplary” is not necessarily to be construed as preferred or advantageous over other embodiments.

In the following detailed description of the embodiments of the disclosure, reference is made to the accompanying drawings that form a part hereof, and in which are shown by way of illustration specific embodiments in which the disclosure may be practiced. It should be understood, however, that it is not intended to limit the disclosure to the forms disclosed, but on the contrary, the disclosure is to cover all modifications, equivalents, and alternatives falling within the spirit and the scope of the disclosure. It is to be understood that other embodiments may be utilized and that changes may be made without departing from the scope of the present disclosure. The following description is, therefore, not to be taken in a limiting sense.

The terms “comprises”, “comprising”, or any other variations thereof are intended to cover a non-exclusive inclusion such that a setup, device, or method that comprises a list of components or steps does not include only those components or steps but may include other components or steps not expressly listed or inherent to such setup, device, or method. In other words, one or more elements in a system or apparatus proceeded by “comprises . . . a” does not, without more constraints, preclude the existence of other elements or additional elements in the system or method.

The terms “includes”, “including”, or any other variations thereof are intended to cover a non-exclusive inclusion such that a setup, device, or method that includes a list of components or steps does not include only those components or steps but may include other components or steps not expressly listed or inherent to such setup, device, or method. In other words, one or more elements in a system or apparatus proceeded by “includes . . . a” does not, without more constraints, preclude the existence of other elements or additional elements in the system or method.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has”, “have”, “having”, or the like are intended to be open-ended terms. Further, the phrase “based on” is intended to mean “based at least in partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

As used herein, the terms “communication”, “communicate”, “send”, and/or “receive” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “server” and/or “processor” may refer to one or more computing devices or computing units, such as processors, storage devices, and/or similar computer components, that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor”, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present disclosure relate to computer-implemented methods and/or payment servers for operating a lock. The computer-implemented method may include receiving a payment transaction request and one or more details associated with a lock. Further, the computer-implemented method may include providing one of a success message or a failure message to an access management system to operate the lock based on a result of authorization of the payment transaction request and a result of a validation of the one or more details.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

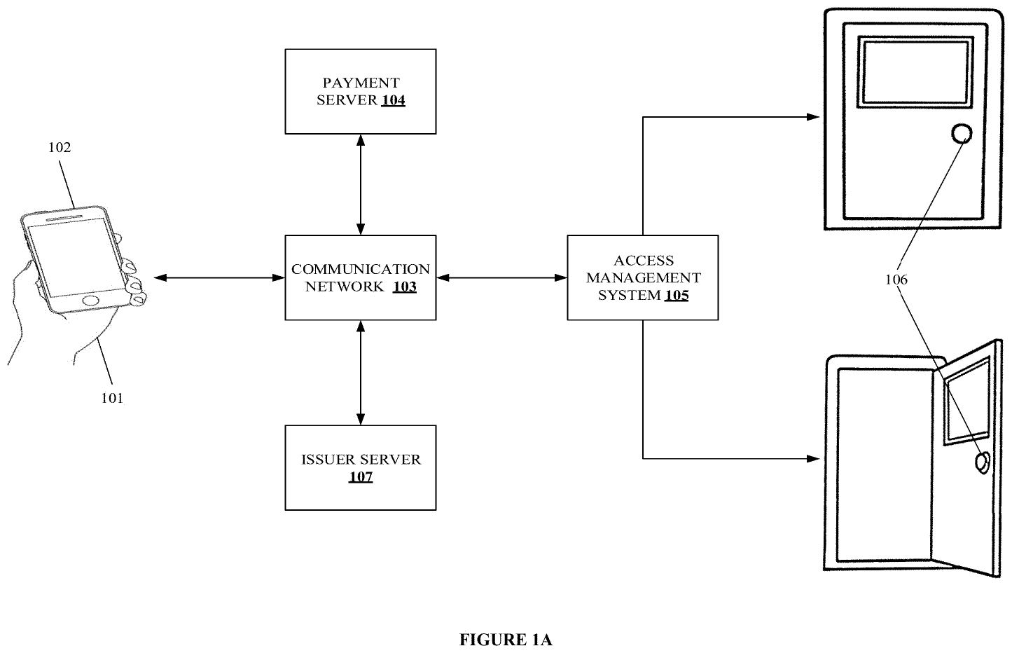

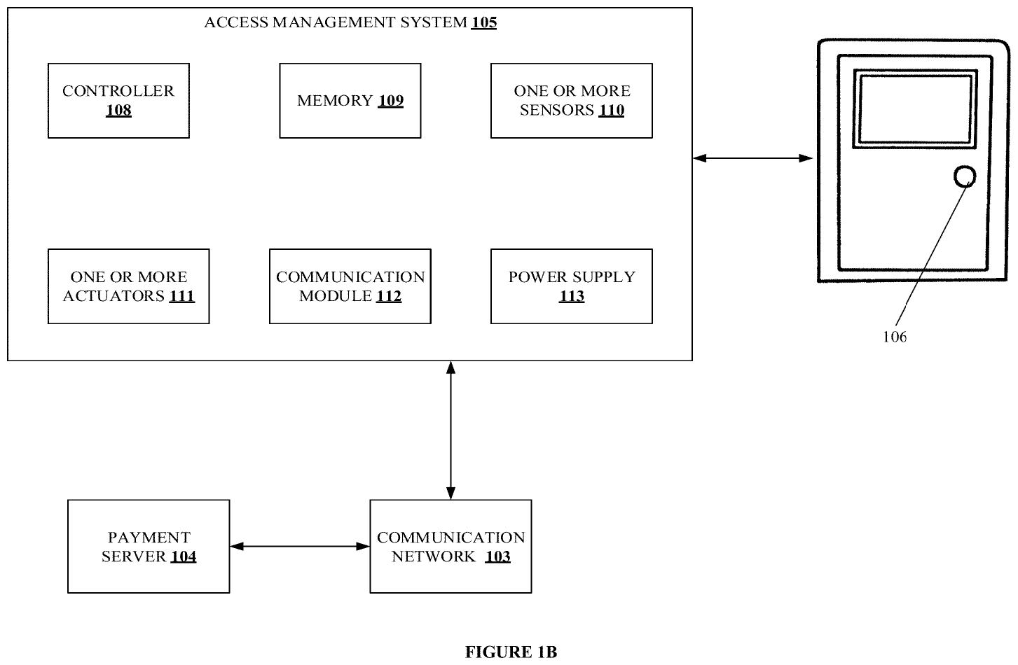

FIG. 1 represents an exemplary environment for operating a lock by performing a payment transaction, in accordance with some non-limiting embodiments or aspects of the present disclosure.

In some non-limiting embodiments or aspects, an access management system (105) is used to operate a lock (106). The lock (106) may be associated with a door, a safety locker, gate, and/or the like. The lock (106) may be used to provide physical access to a user (101). The access management system (105) relates to physical access to the user (101). The access management system (105) may be configured to operate one or more locks. For example, the access management system (105) may operate the locks associated with a building or the locks provided in a portion of the building and/or the like. The access management system (105) may include a controller (108), a memory (109), one or more sensors (110), one or more actuators (111), a communication module (112), and a power supply (113) as shown in FIG. 1B. The controller (108) and the memory (109) are used to detect the status of the lock (106) (for example, the status includes an open state or a closed state) based on the signals from the one or more sensors (110). Further, the controller (108) and the memory (109) are used to operate the lock (106) (for example, from a locked state to an unlocked state or from the unlocked state to the locked state) by providing signals to the one or more actuators (111) associated with the lock (106). The power supply (113) is used to provide power for the operation of the controller (108), the memory (109), the one or more sensors (110), the one or more actuators (111), and the communication module (112). The communication module (112) of the access management system (105) is used to receive a success message or a failure message from a payment server (104) via a communication network (103) as shown in FIG. 1B. Referring back to FIG. 1A, and in some non-limiting embodiments or aspects, the user (101) may operate the lock (106) from the locked state to the unlocked state by performing a payment transaction. The user (101), before performing the payment transaction for operating the lock (106), may need to register one or more details associated with the lock (106) with the payment server (104). The one or more details include a predefined identification value, predefined account information, and a predefined transaction amount associated with the lock (106). The one or more details provided to the payment server (104) during the registration are denoted as the registered information. For example, the one or more details include:
Predefined lock Identification value=1479506,
Predefined account information={Name: User-1, Account Number: 182}, {Name: User-2, Account Number: 147}, and
Predefined transaction amount=368 USD

The user (101) may register the one or more details associated with the lock (106) using an application from a user device (102). The user device (102) may include a smartphone, a laptop, a computer, a tablet computer, a user wearable device, and/or the like. The user (101) may register one or more locks with the payment server (104). Further, the user (101) is labeled as the administrator user (101) and the administrator user (101) may register one or more users with the payment server (104). The one or more users along with the administrator users are capable of operating the lock (106) by performing the payment transaction. For example, the one or more users may be a family member of the administrator user or any person who has trusted relationship with the administrator user. In a business premises environment, the one or more users may be managers or chief security officers, for example. The payment transaction may be performed using at least one of Internet banking, a credit card, a prepaid card, an e-wallet payment application, and/or the like.

In some non-limiting embodiments or aspects, the user (101) via the user device (102) initiates the payment transaction along with the one or more details for operating the lock (106) from the locked state to the unlocked state. The payment server (104) receives a payment transaction request and the one or more details associated with the lock (106). For example, the payment transaction request and the one or more details received by the payment server (104) is
Payer Account Information={Name: User-2, Account Number: 147},
Payee Account Information={Name: Psuedo_Merchant_1, Account Number: 950},
lock Identification value=1479506,
Transaction amount=368 USD.

The payee account information includes the name and the account number for which the transaction amount is credited. In some non-limiting embodiments or aspects, the payee account information may be provided by the user (101) while registering the lock (106) with the payment server (104). In some non-limiting embodiments or aspects, the payment server (104) may provide the payee account information while registering the lock (106). The payment server (104) provides the payment transaction request to an issuer server (107) for authorization. The issuer server (107) verifies details of the payment transaction. For example, if the payment transaction was initiated by a payment card, the issuer server (107) verifies a card number, a CVV, an expiry date, funds available with the user (101) account, and/or the like. Further, the payment server (104) receives from the issuer server (107) the result of the authorization indicative of success or failure.

In some non-limiting embodiments or aspects, the issuer server (107) based on the payee account information identifies the payment transaction as an access management type message and authorizes the payment transaction based on the verification. Further, the issuer server (107) may not initiate a transfer of the transaction amount between the payer account and the payee account. Upon receiving the result of authorization indicative of the failure, the payment server (104) provides a failure message to the access management system (105) to retain the lock (106) in a locked state and provides a failure message to the user (101) indicating a failure to operate the lock (106) from a locked state to the unlocked state.

In some non-limiting embodiments or aspects, upon receiving the result of authorization indicative of success, the payment server (104) validates the one or more details of the lock (106) received along with the payment transaction request with the one or more details received from the user (101) during the registration of the lock (106). The payment sever provides a success message to the access management system (105) and the user (101) when the one or more details of the lock (106) received along with the payment transaction request match with the registered information. Alternatively, the payment sever provides a failure message to the access management system (105) and the user (101) when the one or more details of the lock (106) received along with the payment transaction request mismatches with the registered information. The access management system (105), upon receiving the success message, unlocks the lock (106) after verifying sender information, a timestamp, and the identification value of the lock (106) associated with the success message. The sender information, for example, includes a mobile number, an Internet Protocol (IP) address associated with the payment server (104) used for sending the success message or the failure message to the access management system (105). The payment server (104) initiates an authorization reversal request after sending the success message to the access management system (105). The authorization reversal request refunds the transaction amount to the payer account. Further, the access management system (105), upon receiving the failure message, retains the lock (106) in a locked state.

In some non-limiting embodiments or aspects, the user device (102), the payment server (104), the issuer server (107), and the access management system (105) are interconnected via a communication network (103) for communicating with each other. Further, the communication network (103) may include, for example, a direct interconnection, e-commerce network, a peer to peer (P2P) network, local area network (LAN), wide area network (WAN), wireless network (e.g., using Wireless Application Protocol), the Internet, Wi-Fi®, cellular network, wired network, short-range communication, and/or the like.

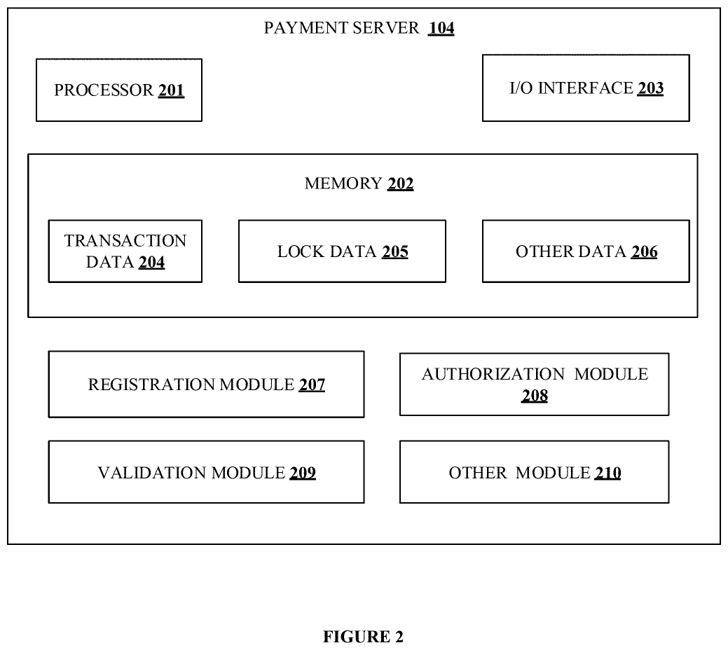

FIG. 2 shows a simplified block diagram of a payment server (104) for operating the lock (106) based on the payment transaction, in accordance with some non-limiting embodiments or aspects of the present disclosure.

In some non-limiting embodiments or aspects, the payment server (104) may include at least one Central Processing Unit (“CPU” or “processor”) (201) and a memory (202) storing instructions executable by the at least one processor (201). The processor (201) may comprise at least one data processor for executing program components for executing user- or system-generated requests. The memory (202) is communicatively coupled to the processor (201). The payment server (104) further comprises an Input/Output (I/O) interface (203). The I/O interface (203) is coupled with the processor (201) through which an input signal or/and an output signal is communicated. In some non-limiting embodiments or aspects, the data stored in the memory (202) may include transaction data (204), lock data (205), and other data (206).

In some non-limiting embodiments or aspects, the transaction data (204) may include details regarding the payment transaction request. For example, the payment transaction request may include the payer account information or the payer payment card details, payee account information, name of a bank associated with the payer and the payee, authentication request, authorization request, and/or the like. The person skilled in the art appreciates the use of one or more formats for initiating the payment transaction request using the payment card, the e-wallet application, and Internet banking.

In some non-limiting embodiments or aspects, the lock data (205) may include the registered information associated with the lock (106) and the one or more details received along with the payment transaction request. The registered information includes the predefined identification value, the predefined transaction amount, and the predefined account information of one or more users associated with the lock (106). The one or more details include the identification value, the transaction amount, and the account information of the user (101) received along with the payment transaction request.

In some non-limiting embodiments or aspects, other data (206) may include at least one of the success messages including at least one of the following: sender information, a timestamp, an identification value associated with the lock (106), the failure message including a timestamp, an identification value associated with the lock (106), or any combination thereof.

In some non-limiting embodiments or aspects, a registration module (207) is configured to receive the registration information from the user (101) via the application installed in the user device (102). The registration information (including the predefined identification value, the predefined transaction amount, and the predefined account information of one or more users associated with the lock (106)) is stored in the lock data (205). In some non-limiting embodiments or aspects, an authorization module (208) is configured to provide the payment transaction request to the issuer server (107) for authorization. Further, the authorization module (208) is configured to receive the result of the authorization indicative of success or failure from the issuer server (107). Furthermore, the authorization module (208) is configured to initiate the authorization reversal request after sending the success message to the access management system (105) for refunding the transaction amount to the payer account.

In some non-limiting embodiments or aspects, a validation module (209) is configured to verify the one or more details received from the user (101) with the registration information stored in the lock data (205). Further, the validation module (209) is configured to generate the result of the validation indicative of success or failure based on the verification of the one or more details. The success message or the failure message is provided to the access management system (105) and the user device (102). In some non-limiting embodiments or aspects, the other module (210) is configured to receive a notification from the access management system (105) about restoring the lock (106) to a locked state after one of a predefined time period or a user (101) manually locking the lock (106).

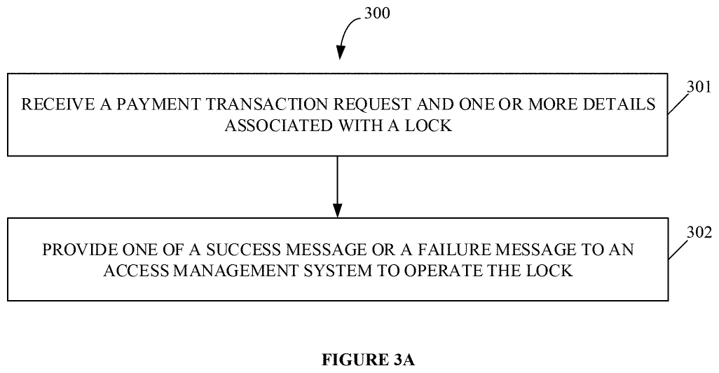

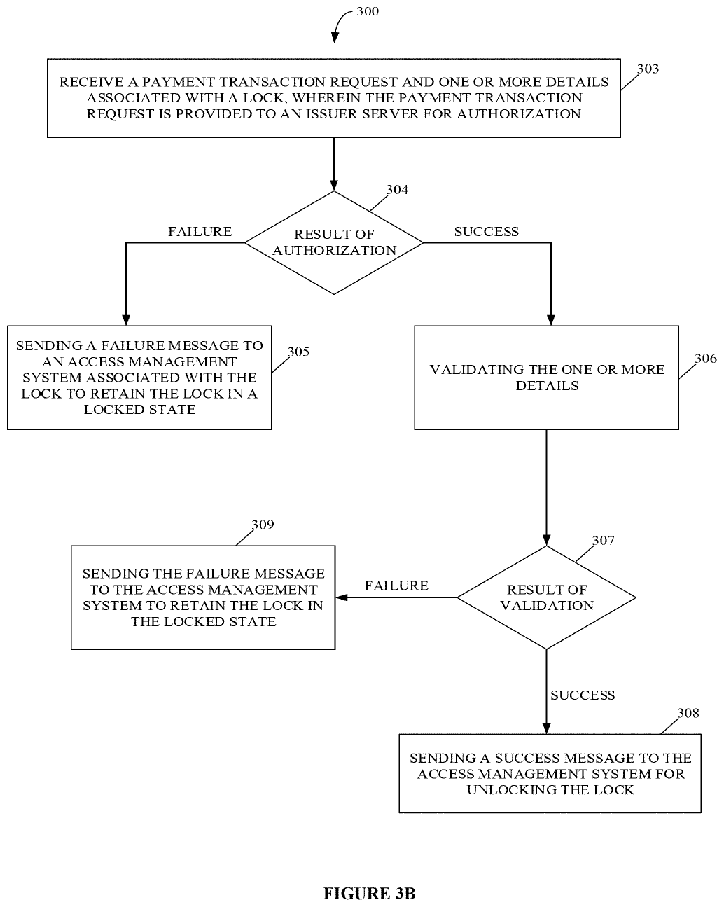

FIG. 3A is a flow chart illustrating method steps for operating the lock (106) by performing the payment transaction, in accordance with some non-limiting embodiments or aspects of the present disclosure.

The order in which the computer-implemented method 300 is described is not intended to be construed as a limitation, and any number of the described method blocks may be combined in any order to implement the computer-implemented method. Additionally, individual blocks may be deleted from the computer-implemented method without departing from the spirit and scope of the subject matter described herein. Furthermore, the computer-implemented method may be implemented in any suitable hardware, software, firmware, or combination thereof.

At step 301, the payment server (104) receives the payment transaction request and the one or more details associated with the lock (106). In some non-limiting embodiments or aspects, the payment transaction request is initiated by the user (101) using the user device (102). In some non-limiting embodiments or aspects, the user (101) registers the one or more details associated with the lock (106) for operating the lock (106) by performing the payment transaction. The one or more details include the identification value, the account information, and the transaction amount associated with the lock (106). The user (101) may register one or more users for the lock (106). Further, the user (101) may register the one or more locks with the one or more users with the payment server (104).

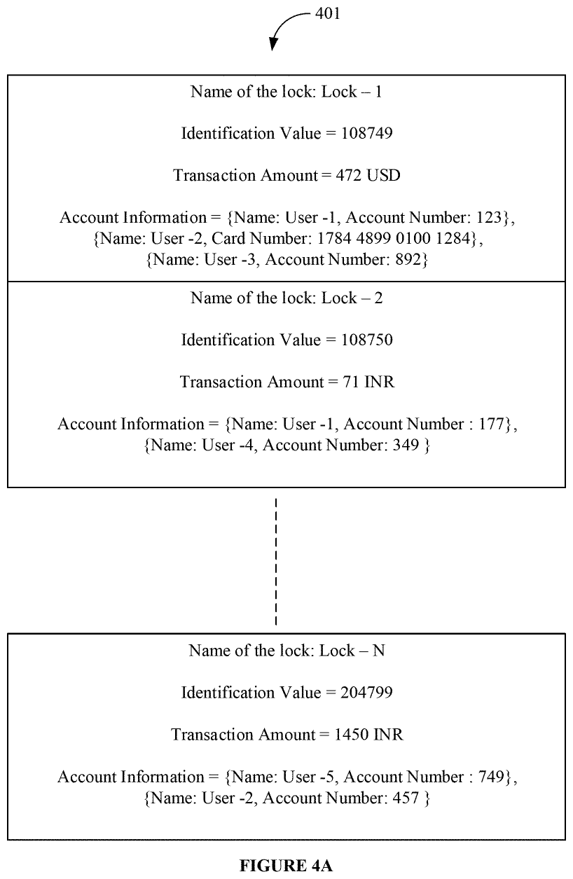

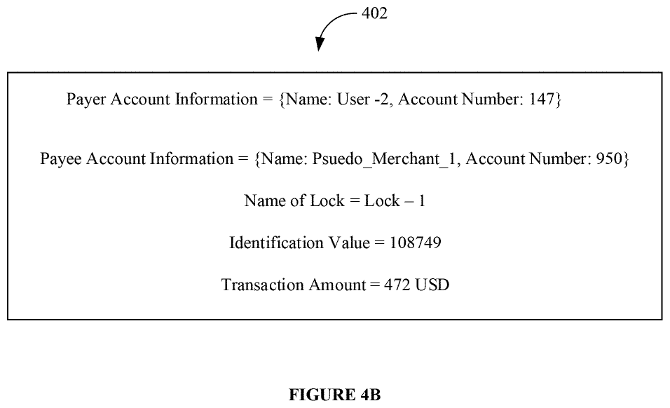

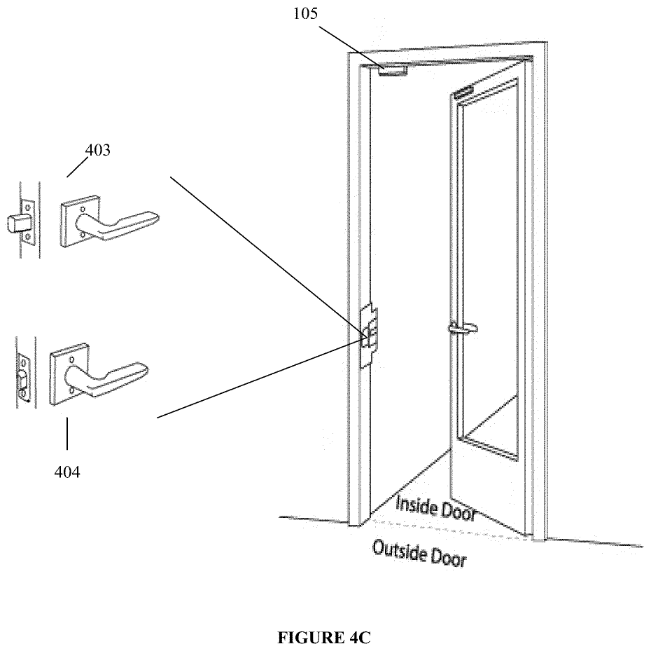

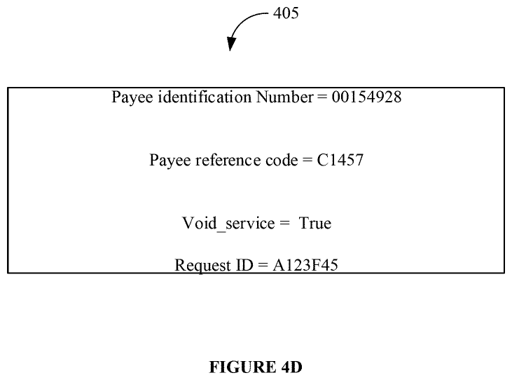

In some non-limiting embodiments or aspects, the payment server (104) receives the registration request from the user (101) via the application in the user device (102). The registration request includes the predefined identification value, the predefined transaction amount, and the predefined account information of the one or more users associated with the lock (106). The identification value associated with the lock (106) may be an alpha-numeric string used to uniquely identify the lock (106). The predefined transaction amount may include a value of the payment transaction amount and a type of currency associated with the value. The predefined account information may include the account number or the payment card number from which the payment transaction request will be initiated. Further, the payment server (104) stores the predefined identification value, the predefined transaction amount and the predefined account information in a database as the registered information. The database may be external to the payment server (104) or implemented in the memory (202) of the payment sever. For example, the registered information for the one or more locks is shown in FIG. 4A.

In some non-limiting embodiments or aspects, the payment transaction request may include the payer account information (e.g., the account information of the user (101)), the payee account information, the transaction amount, authentication request, and the authorization request. For example, the payment transaction request received from the user (101) via the user device (102) is shown in FIG. 4B.

In some non-limiting embodiments or aspects, the payment server (104) provides the payment transaction request to an issuer server (107) for authentication and/or authorization, as shown in step 303 of FIG. 3B. The issuer server (107) verifies the payer account information, payee account information, and/or the like. The person skilled in the art appreciates the use of one or more authentication and/or authorization techniques including, for example, a personal identification number, a static password, a short message service based one-time password, and/or the like. Further, the payment server (104) receives the result of the authentication and/or authorization indicative of a success or a failure from the issuer server (107) as shown in step 304 of FIG. 3B. The success indicates that the payer account information and the payee account information are valid and the failure indicates an error in at least one of the payer account, payee account, the transaction amount, and/or the like.

In some non-limiting embodiments or aspects, a balance amount present in the payer account may not affect the result of authorization. For example, if the balance amount in the payer account is “300$” and the transaction amount associated with the payment transaction request is “550$”, the result of the authorization indicates success if the verification of the payer information, payee information, and the transaction amount is successful. The payment transaction request is authorized, and the transaction amount is not transferred from the payer account to the payee account. When the result of the authorization is indicative of failure, the payment server (104) may send a failure message to an access management system (105) associated with the lock (106) to retain the lock (106) in a locked state as shown in step 305 of FIG. 3B. When the result of the authorization is indicative of success, the payment server (104) may validate the one or more details received along with the payment transaction request as shown in step 306 of FIG. 3B.

Referring to FIG. 3A, at step 302, the payment server (104) provides one of the success message or the failure message to the access management system (105) to operate the lock (106) based on the result of authorization of the payment transaction request and the result of the validation of the one or more details. In some non-limiting embodiments or aspects, the payment server (104) validates the one or more details by verifying the one or more details including the identification value associated with the lock (106), the account information associated with the payment transaction request, and the transaction amount associated with the payment transaction request with the registered information stored in the database as shown in step 306 of FIG. 3B. For example, the one or more details received from the user (101) along with the payment transaction request for the “lock-1” as shown in FIG. 4B is verified with the corresponding registered information of the “lock-1” as shown in FIG. 4A.

Further, the payment server (104) generates the result of the validation indicative of success or failure based on the verification of the one or more details as shown in step 307 of FIG. 3B. The success of the validation indicates that the one or more details received from the user (101) match with the registered information of the lock (106). The failure of the validation indicates a mismatch between the one or more details received from the user (101) and the registered information of the lock (106), for example, an incorrect transaction amount or incorrect payer account information (e.g., account information of the user (101)) and/or the like.

In some non-limiting embodiments or aspects, the payment server (104) provides the success message by sending at least one of sender information, the timestamp, and the identification value to the access management system (105) for unlocking the lock (106), as shown in step 308 of FIG. 3B. The success message is sent to the access management system (105) when the result of the authorization and the result of the validation is indicative of success. Further, the access management system (105) is configured to unlock the lock (106) (e.g., operate the lock (106) from the locked state (403) to the unlocked state (404)) as shown in FIG. 4C after verifying the sender information, the timestamp, and the identification value associated with the success message.

The difference between the timestamp associated with the message and the current timestamp in the access management system (105) may be set to a predetermined value, for example, 2 minutes. If the difference is greater than the predetermined value, the access management system (105) treats the success message as invalid and does not operate the lock (106). For example, if the success message with the timestamp of “10:00 AM on 9 Dec. 2010” is received by the access management system (105) at “10:30 AM on 9 Dec. 2010” or at “10:00 AM on 10 Dec. 2010”, the access management system (105) regards the success message as invalid and does not operate the lock (106). In some non-limiting embodiments or aspects, the payment server (104) sends the failure message to the access management system (105) associated with the lock (106) to retain the lock (106) in a locked state (403), when the result of authorization or the result of validation is indicative of failure, as shown in step 309 of FIG. 3B.

In some non-limiting embodiments or aspects, the payment server (104) initiates an authorization reversal request after sending the success message to the access management system (105). The authorization reversal request refunds the transaction amount associated with the payment transaction before the final settlement is complete. The authorization reversal returns the transaction amount to the user (101), either by releasing the hold on the user (101) transaction amount in the payer account or by transferring money from the payee account to the payer account. The authorization reversal is performed by generating a void request (405) as shown in FIG. 4D, either by the payment server (104) or the user device (102). The void request (405) is a follow-on transaction based on a request ID. The request ID is a value generated upon capturing the payment transaction request by the payment server (104) or the issuer server (107).

In some non-limiting embodiments or aspects, the payment server (104) receives a notification from the access management system (105) about restoring the lock (106) to a locked state (403) after one of a predefined time period (for example, 5 minutes) or a user (101) manually locking the lock (106). The access management system (105) detects the manual locking of the lock (106) by the user (101) using the one or more sensors (for example, an infrared sensor, an ultrasound sensor, and/or the like) associated with the lock (106). In some non-limiting embodiments or aspects, the access management system (105), upon determining the absence of any user (101) in the vicinity of the lock (106) or the absence of any physical opposition to the door or the gate associated with the lock (106), may restore the lock (106) to the locked state (403) after the predefined time period.

The computer-implemented method of operating the lock (106) based on the payment transaction includes operating the lock (106) from the locked state (403) to the unlocked state (404) after the successful authorization of the payment transaction request and the validation of the one or more details with the registered information. The security associated with the lock (106) is equivalent to the security associated with the payment transaction performed by the user (101). Each lock (106) is associated with the transaction amount predetermined by the user (101), and therefore, the predetermined transaction acts as a key for unlocking the lock (106). Unauthorized users cannot operate the lock (106) without the knowledge of the predefined transaction amount. Further, the account information of the one or more users capable of operating the lock (106) is registered by the user (101). Therefore, the payment transaction request initiated by unauthorized users with the matching transaction amount will fail to operate the lock (106) as the account information of the unauthorized users is not registered by the user (101). The access management system (105) operates the lock (106) after verifying the sender of the success message and the timestamp associated with the success message. Therefore, the same success message cannot be reused by the other users or the user (101) to operate the lock (106) at a later point in time. The payment transaction enables the user (101) to remotely operate the lock (106) without the need of the physical presence of the user (101) in the vicinity of the lock. The payment transaction to operate the lock provides hassle free operation of the lock (106) without the need of remembering the pins, passwords for the one or more locks, and misplacing and forgetting of the physical key. The operation of the lock (106) made by the user (101) and the one or more users is tracked easily using the payment transaction statement provided by the issuer bank.

### Computer System

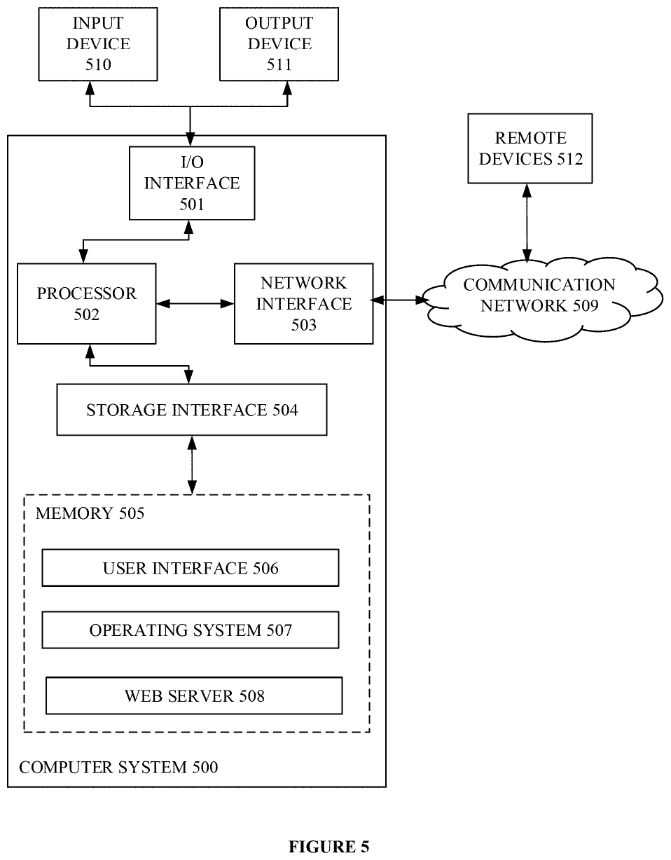

FIG. 5 illustrates a block diagram of an exemplary computer system (500) for implementing embodiments consistent with the present disclosure. In some non-limiting embodiments or aspects, the computer system (500) may be used to implement the computer-implemented method for operating the lock (106) based on the payment transaction. The computer system (500) may comprise a central processing unit (“CPU” or “processor”) (502). The processor (502) may comprise at least one data processor for executing program components for dynamic resource allocation at run time. The processor (502) may include specialized processing units such as integrated system (bus) controllers, memory management control units, floating point units, graphics processing units, digital signal processing units, etc.

The processor (502) may be disposed in communication with one or more input/output (I/O) devices (not shown) via an I/O interface (501). The I/O interface (501) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.1 n /b/g/n/x, Bluetooth, cellular (e.g., code-division multiple access (CDMA), high-speed packet access (HSPA+), global system for mobile communications (GSM), long-term evolution (LTE), WiMax®, or the like), etc.

Using the I/O interface (501), the computer system (500) may communicate with one or more I/O devices. For example, an input device (510) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (511) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some-non-limiting embodiments or aspects, the computer system (500) is connected to the service operator through a communication network (509). The processor (502) may be disposed in communication with the communication network (509) via a network interface (503). The network interface (503) may communicate with the communication network (509). The network interface (503) may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network (509) may include, without limitation, a direct interconnection, e-commerce network, a peer to peer (P2P) network, local area network (LAN), wide area network (WAN), wireless network (e.g., using Wireless Application Protocol), the Internet, Wi-Fi®, etc. Using the network interface (503) and the communication network (509), the computer system (500) may communicate with the one or more service operators.

In some-non-limiting embodiments or aspects, the processor (502) may be disposed in communication with a memory (505) (e.g., RAM, ROM, etc. not shown in FIG. 5) via a storage interface (504). The storage interface (504) may connect to memory (505) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (505) may store a collection of program or database components, including, without limitation, a user interface (506), an operating system (507), a web server (508), etc. In some-non-limiting embodiments or aspects, the computer system (500) may store user/application data, such as the data, variables, records, etc. as described in this disclosure. Such databases may be implemented as fault-tolerant, relational, scalable, secure databases such as Oracle or Sybase.

The operating system (507) may facilitate resource management and operation of the computer system (500). Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® 10S®, GOOGLE™ ANDROID™, BLACKBERRY® OS, or the like.

In some-non-limiting embodiments or aspects, the computer system (500) may implement a web browser (not shown FIG. 5) stored program component. The web browser (not shown in FIG. 5) may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, ADOBE® FLASH®, JAVASCRIPT®, JAVA®, Application Programming Interfaces (APIs), etc. In some-non-limiting embodiments or aspects, the computer system (500) may implement a mail server (not shown in FIG. 5) stored program component. The mail server may be an Internet mail server such as Microsoft Exchange, or the like. The mail server (not shown in FIG. 5) may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® Exchange, Post Office Protocol (POP), Simple Mail Transfer Protocol (SMTP), or the like. In some-non-limiting embodiments or aspects, the computer system (500) may implement a mail client (not shown in FIG. 5) stored program component. The mail client (not shown in FIG. 5) may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

The described operations may be implemented as a method, system, or article of manufacture using standard programming and/or engineering techniques to produce software, firmware, hardware, or any combination thereof. The described operations may be implemented as code maintained in a “non-transitory computer-readable medium”, where a processor may read and execute the code from the computer-readable medium. The processor is at least one of a microprocessor and a processor capable of processing and executing the queries. A non-transitory computer-readable medium may include media, such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, and the like), and the like. Further, non-transitory computer-readable media may include all computer-readable media except for a transitory. The code implementing the described operations may further be implemented in hardware logic (e.g., an integrated circuit chip, Programmable Gate Array (PGA), Application Specific Integrated Circuit (ASIC), and the like).

In some non-limiting embodiments or aspects, the computer system (500) may receive at least one of the payment transaction request, one or more details associated with the payment transaction, and the registered information from remote devices (512) via a communication network (509).

An “article of manufacture” includes non-transitory computer readable medium and/or hardware logic in which code may be implemented. A device in which the code implementing the described embodiments of operations are encoded may include a computer-readable medium or hardware logic. Of course, those skilled in the art will recognize that many modifications may be made to this configuration without departing from the scope of the disclosure and that the article of manufacture may include suitable information bearing medium known in the art.

The terms “some non-limiting embodiments or aspects”, “embodiment”, “embodiments”, “the embodiment”, “the embodiments”, “one or more embodiments”, “some-non-limiting embodiments or aspects”, and “one embodiment” mean “one or more (but not all) embodiments of the disclosure(s)” unless expressly specified otherwise. A description of an embodiment with several components in communication with each other does not imply that all such components are required. On the contrary, a variety of optional components is described to illustrate the wide variety of possible embodiments of the disclosure.

The terms “including”, “comprising”, “having”, and variations thereof mean “including but not limited to” unless expressly specified otherwise. The enumerated listing of items does not imply that any or all of the items are mutually exclusive unless expressly specified otherwise. The terms “a”, “an”, and “the” mean “one or more” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIG. 3 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

What is claimed is:

1. A computer-implemented method comprising:
receiving, with at least one processor, a payment transaction request and one or more details associated with a lock; and
providing, with at least one processor, one of a success message or a failure message to an access management system to operate the lock based on a result of authorization of the payment transaction request and a result of a validation of the one or more details.

2. The computer-implemented method of claim 1, wherein the one or more details comprise at least one of the following: an identification value, account information, a transaction amount associated with the lock, or any combination thereof.

3. The computer-implemented method of claim 1, further comprising:
providing, with at least one processor, the payment transaction request to an issuer server for authorization; and
receiving, with at least one processor, the result of the authorization indicative of a success or a failure from the issuer server.

4. The computer-implemented method of claim 1, wherein the validation of the one or more details comprises:
verifying the one or more details comprising an identification value associated with the lock, account information associated with the payment transaction request, and a transaction amount associated with the payment transaction request with registered information stored in a database; and
generating the result of the validation indicative of success or failure based on the verification of the one or more details.

5. The computer-implemented method of claim 1, wherein providing the success message comprises sending the success message comprising at least one of sender information, a timestamp, and an identification value to the access management system for unlocking the lock, when the result of authorization and the result of the validation is indicative of success, wherein the lock is unlocked by the access management system after verifying the sender information, the timestamp, and the identification value associated with the success message.

6. The computer-implemented method of claim 1, wherein providing the failure message comprises sending the failure message to the access management system associated with the lock to retain the lock in a locked state, when the result of authorization or the result of the validation is indicative of failure.

7. The computer-implemented method of claim 1, further comprising initiating, with at least one processor, an authorization reversal request after sending the success message to the access management system.

8. The computer-implemented method of claim 1, further comprising receiving, with at least one processor, a notification from the access management system about restoring the lock to a locked state after one of a predefined time period or a user manually locking the lock.

9. The computer-implemented method of claim 1, further comprising receiving, with at least one processor, a registration request for operating the lock, wherein the registration request comprises a predefined identification value, a predefined transaction amount, and predefined account information of one or more users associated with the lock; and
storing, in a database, the predefined identification value, the predefined transaction amount, and the predefined account information of one or more users as registered information.

10. A payment server for operating a lock comprising:
at least one processor; and
a memory communicatively coupled to the at least one processor, wherein the memory stores processor instructions, which, when executed, cause the at least one processor to:
receive a payment transaction request and one or more details associated with the lock; and
provide one of a success message or a failure message to an access management system to operate the lock based on a result of authorization of the payment transaction request and a result of validation of the one or more details.

11. The payment server of claim 10, wherein the at least one processor is configured to receive the one or more details comprising at least one of the following: an identification value, account information, a transaction amount associated with the lock, or any combination thereof.

12. The payment server of claim 10, wherein the at least one processor is configured to:
provide the payment transaction request to an issuer server for authorization; and
receive the result of the authorization indicative of a success or a failure from the issuer server.

13. The payment server of claim 10, wherein the at least one processor is configured to validate the one or more details by:
verifying the one or more details comprising an identification value associated with the lock, account information associated with the payment transaction request, and a transaction amount associated with the payment transaction request with registered information stored in a database; and
generating the result of the validation indicative of success or failure based on the verification of the one or more details.

14. The payment server of claim 10, wherein the at least one processor is configured to provide the success message by sending the success message to the access management system for unlocking the lock, when the result of the authorization and the result of the validation is indicative of success, wherein the lock is unlocked by the access management system after verifying sender information, a timestamp, and an identification value associated with the success message.

15. The payment server of claim 10, wherein the at least one processor is configured to provide the failure message by sending the failure message to the access management system associated with the lock to retain the lock in a locked state, when the result of the authorization or the result of the validation is indicative of failure.

16. The payment server of claim 10, wherein the at least one processor is further configured to initiate an authorization reversal request after sending the success message to the access management system.

17. The payment server of claim 10, wherein the at least one processor is further configured to receive a notification from the access management system about restoring the lock to a locked state after a predefined time period.

18. The payment server of claim 10, wherein the at least one processor is further configured to:
receive a registration request for operating the lock, wherein the registration request comprises a predefined identification value, a predefined transaction amount, and predefined account information of one or more users associated with the lock; and
store, in a database, the predefined identification value, the predefined transaction amount, and the predefined account information of one or more users as registered information.

19. A computer-implemented method comprising:
receiving, with at least one processor, a payment transaction request and one or more details associated with a lock, wherein the payment transaction request is provided to an issuer server for authorization;
in response to receiving a result of the authorization, performing, with at least one processor, at least one of the following: sending a failure message to an access management system associated with the lock to retain the lock in a locked state, when the result of the authorization is indicative of failure; validating the one or more details, when the result of the authorization is indicative of success; or any combination thereof; and
in response to a result of the validation, performing, with the at least one processor, at least one of the following: sending a success message to the access management system for unlocking the lock, when the result of the validation is indicative of success; sending the failure message to the access management system to retain the lock in the locked state, when the result of validation is indicative of failure; or any combination thereof.

20. The computer-implemented method of claim 19, wherein the validating the one or more details comprises:
verifying, with at least one processor, the one or more details comprising an identification value associated with the lock, account information associated with the payment transaction request, and a transaction amount associated with the payment transaction request with registered information stored in a database; and
generating, with at least one processor, the result of the validation indicative of success or failure based on the verification of the one or more details.
